(19) United States
(12) Patent Application Publication
(10) Pub. No.: US 2025/0108539 A1
(43) Pub. Date: Apr. 3, 2025

(54) RESOURCE RECOVERY SYSTEM & METHOD

(71) Applicant: SUPACELL PTY LTD, Erina, New South Wales (AU)

(72) Inventor: Ross KESTLE, Erina, New South Wales (AU)

(21) Appl. No.: 18/728,681

(22) PCT Filed: Jan. 11, 2023
(86) PCT No.: PCT/AU2023/050010

§ 371 Date: Jul. 12, 2024

(30) Foreign Application Priority Data
Jan. 13, 2022 (AU) 2022900063

(51) Int. Cl. B29B 17/00; B27N 1/02; B27N 3/00; B27N 3/02; B27N 3/10; B27N 9/00; B29B 17/02; B29B 17/04; B29L 31/10

(52) U.S. Cl. CPC B29B 17/0042; B27N 1/0209; B27N 3/007; B27N 3/02; B27N 3/10; B27N 9/00; B29B 17/04; B29B 17/02; B29B 2017/042; B29L 2031/10

(57) ABSTRACT

Disclosed is a method for recovering waste resources, the method comprising: collecting co-mingled commodity streams from a waste source; sorting and separating cellulose and soft plastics from among the co-mingled commodity streams; and blending the cellulose and soft plastics together to form a blend of recycled waste; wherein polymeric fibrous material is blended together with the blend of recycled waste.

### TECHNICAL FIELD

This disclosure relates generally to a resource recovery system and method.

### BACKGROUND

Materials collected from recycling bins are typically sorted at a Material Recovery Facility (‘MRF’) before being bailed for delivery to a secondary processing site, or export overseas. Historically, recyclable materials collected by many municipal kerbside collections in Australia were often exported overseas to localities where the costs of processing were lower. However, in recent years, countries such as China have been banning the import of foreign waste. In 2016, China imported approximately 7.3 million tonnes of waste plastic, accounting for around 56% of world imports of such waste.

With the waste landscape around the world rapidly changing a new or modified local solution to Australia's, and the world's, growing waste problem may be required. In particular, there may be a need for one or more commercially viable products that reuse recycled waste materials in order to help reduce the volume of waste deposited in landfill. There may also be a need to reduce greenhouse gas emissions, whilst producing improved sustainable and efficient building products.

### SUMMARY OF THE DISCLOSURE

In a first aspect, is disclosed a method for recovering waste resources, the method comprising: collecting co-mingled commodity streams from a waste source; sorting and separating cellulose and soft plastics from among the co-mingled commodity streams; and blending the cellulose and soft plastics together to form a blend of recycled waste.

In some embodiments, polymeric fibrous material may be blended together with the blend of recycled waste.

In some embodiments, prior to the blending step, the method may further comprise shredding the cellulose and soft plastics into smaller particles. In some embodiments, the shredding step of the method may comprise a first shredding of the cellulose and soft plastics to a first particle size and a second shredding, milling and/or fiberizing of the cellulose and soft plastics to a second, smaller particle size.

In some embodiments, the first particle size may have an average particle size of between about 10 to 50 mm in diameter. In some embodiments, the cellulose and soft plastic may preferably be shredded to an average first particle size of about 30 mm diameter.

In some embodiments, the second particle size may have an average particle size of between about 2 to 10 mm in diameter. In some embodiments, the cellulose and soft plastic may preferably be shredded to an average second particle size of about 4 mm to 6 mm diameter.

In some embodiments, the method may further comprise adding fire and/or vermin retardants to the blend of recycled waste either before or after the blending step.

In some embodiments, the cellulose may include at least one of paper or cardboard.

In some embodiments, the soft plastics have a melting temperature below 170° Celsius. In some embodiments, the soft plastics may preferably have a melting temperature below 140° Celsius.

In some embodiments, the blend of recycled waste may comprise less than 50% of the soft plastics that have been recycled.

In some embodiments, the soft plastics may comprise one or more of High Density Polyethylene (HDPE), Medium Density Polyethylene (MDPE), Linear Low Density Polyethylene (LDPE), Polypropylene (PP), and Low Density Polyethylene (LDPE).

In some embodiments, the proportion of the cellulose in the blend of recycled waste may be between approximately 50% and 100% by weight of a total weight of the blend. In some embodiments, the proportion of the cellulose in a blend of the cellulose, plastic and polymeric fibre may preferably be between approximately 70% and 90% by weight of a total weight of the blend.

In some embodiments, the blend of recycled waste may comprise about 80-90% by weight cellulose recovered from a waste source, about 10-20% by weight plastic and polymeric fibres, and about 5-10% by weight fire and/or vermin retardants. In some embodiments, the blend of recycled waste may comprise up to 20% by weight of the fire and/or vermin retardants and/or surfactants. In some embodiments, moisture may also present in the blend of recycled waste and can be between 5-15% by weight. The moisture is typically evaporated out of the blend during the manufacturing process.

In some embodiments, the method may further comprise: laying the blend of recycled waste on a conveyor; and passing the blend of recycled waste through one or more oven modules operating at a temperature high enough to melt low melt polymer binders and/or alternative soft plastic waste whereby the blend is bound into an insulation product.

In some embodiments, non-woven Airlay textile technology may be used in the laying step. In some embodiments, in the laying step, the blend of recycled waste may be formed into one or more of an unbound mat, batt, sheet, and/or board.

In a second aspect, an insulation product is disclosed. The insulation product comprises a blend of raw materials from one or more commodity streams collected from a co-mingled waste source.

In some embodiments, the one or more commodity streams may include at least one or both of cellulose and soft plastics. In some embodiments, the cellulose may include at least one of paper or cardboard.

In some embodiments, the soft plastics have a melting temperature below 170° Celsius. In some embodiments, the soft plastics may preferably have a melting temperature below 140° Celsius.

In some embodiments, fire and/or vermin retardants and/or surfactants may be added to the blend of raw materials.

In some embodiments, the insulation product may be unbound. In some embodiments, the unbound insulation product may take the form of loose mulch or Cellulose Fibre Insulation (CFI).

In some embodiments, polymeric fibrous material may be added to blend of raw materials.

In some embodiments, the insulation product may be formed into bound or bonded cellulose fibre-based insulation. In some embodiments, the bound or bonded cellulose fibre-based insulation may take the form of a batt, mat, wadding, fibre particle board.

In some embodiments, the proportion of the cellulose in the insulation product is between approximately 50% and 90% by weight of a total weight of the blend depending on the type of product, density and aesthetic requirements. In some embodiments, the proportion of the cellulose in the insulation product may preferably be between approximately 80% and 90% by weight of a total weight of the blend. In some embodiments, the proportion of the polymeric fibrous material in the insulation product may preferably be between approximately 5% and 55% by weight of a total weight of the blend. In some embodiments, the blend of recycled waste may comprise up to 20% by weight fire and/or vermin retardants and/or surfactants. In some embodiments, moisture may also present in the blend of recycled waste and can be between 5-15% by weight. The moisture is typically evaporated out of the blend during the manufacturing process.

In one preferred embodiment, the blend of recycled waste may comprise about 80-85% by weight cellulose recovered from a waste source, about 10-15% by weight polymeric fibres, and about 5-10% by weight fire and/or vermin retardants and/or surfactants.

In a further aspect, a method is disclosed of producing insulation materials from a waste sources, the method comprising: collecting co-mingled commodity streams from the waste source; sorting and separating cellulose and soft plastics from among the co-mingled commodity streams; and blending the cellulose and soft plastics together to form a blend of recycled waste.

In some embodiments, the features of the method may be in accordance with those features described above in relation to the first aspect.

In yet a further aspect, embodiments are disclosed of a method for recovering waste resources to manufacture products that are suitable for use as insulation. The method comprises sorting and selecting the raw materials from collected waste sources. The selected raw materials are then processed and mixed into an unbound fibrous blend of waste paper, waste cardboard, waste plastic. In some forms, low melt polymer binders and/or fire and vermin retardants and/or other additives can be added to the mix as required. The unbound blend of recycled raw materials is then laid out onto a conveyor belt and passed through one or more oven modules that are operated at temperatures high enough to melt the low melt polymer binders and an alternative soft plastic waste so as to cause the blend to bind into a usable insulation product. Whilst in some forms, the final insulation may be unbound mulch, in some alternative forms, the final insulation product may be bound to a degree whereby it may be handled without disintegrating or losing its structural integrity.

Other aspects, features, and advantages will become apparent from the following detailed description when taken in conjunction with the accompanying drawings, which are a part of this disclosure and which illustrate, by way of example, principles of inventions disclosed.

### DESCRIPTION OF THE FIGURES

The accompanying drawings facilitate an understanding of the various embodiments. The invention will now be described, by way of non-limiting example only, with reference to the accompanying drawings, in which:

FIG. 1 is a graphical representation of an embodiment of the disclosed method for recovering waste resources, including the utilisation of recovered waste resources with cellulose fibre products.

FIG. 2 is a graphical representation of an embodiment of the manufacturing process and excludes the initial waste collection and sorting steps from which raw materials are provided.

### DETAILED DESCRIPTION

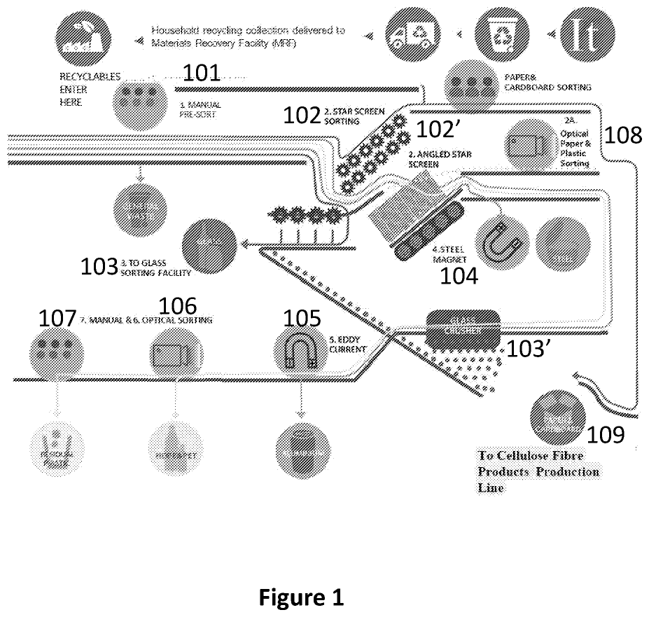

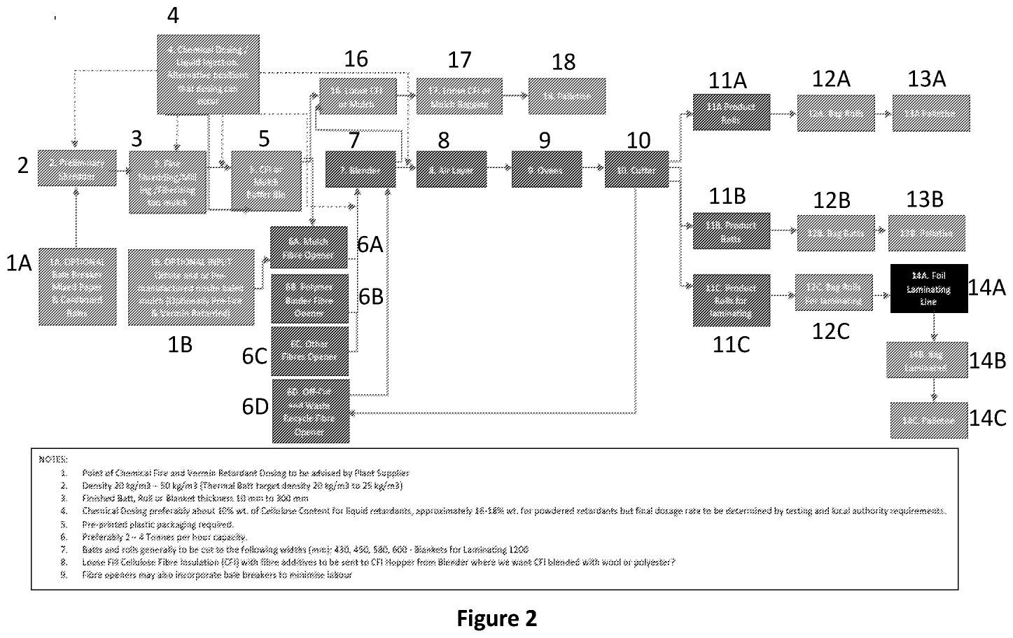

Referring to the drawings, there is illustrated an embodiment of the disclosed method for recovering waste resources (FIG. 1) and an embodiment of the manufacturing process from which a cellulose fibre product can be manufactured using the recovered waste resources (FIG. 2). Where like reference numerals are used in the following description, the features are considered to be the same unless specified as being otherwise.

The disclosed method includes the selection, combination and processing of recycled waste paper, cardboard and low melt soft plastics, that have preferably been sourced from domestic and/or commercial recycling and/or garbage collection operations. The method can be used to manufacture a loose unbound mulch or Cellulose Fibre Insulation (CFI) or a bound or bonded product of integrated recycled cellulose, depending on whether binding or adhesive materials are used during the manufacturing process to form the bound insulation products.

Insulation is typically made from virgin flexible fibers, most commonly fiberglass, mineral (rock and slag) wool, plastic fibers, and natural fibers, such as cotton and sheep's wool. The presently disclosed method advantageously uses co-mingled unclean, polluted and/or contaminated raw materials that have been sourced directly from residential or commercial waste bins, skips and dumpsters, and does not require that all of the input materials be clean raw cellulose fibre materials, such as clean recycled newsprint and cardboard. The co-mingled waste may include a combination of one or more of paper, cardboard, plastics, glass, metal and other waste materials.

Paper and cardboard that are disposed of in a landfill decompose over time releasing methane into the environment. Methane is considered a potentially harmful greenhouse gas, having approximately twenty five times the impact of an equivalent volume of carbon dioxide. Studies have shown that recycling paper or cardboard may advantageously reduce such emissions by 0.6 tonnes of carbon dioxide per tonne of paper or cardboard recycled. The resource recovery method may thus help to reduce the volume of recyclable materials being deposited in landfill, as the method improves the quantity of co-mingled recyclables that can be recycled and repurposed.

The disclosed method facilitates the removal of all, or at least a majority, of the contaminants from the cellulose fibre, with the exception of soft low melt plastics that can be used as a binder. Where reference is made to soft plastics, this typically refers to plastics which can be easily scrunched, such as plastic food wrappers like chip packets, plastic bags, freezer bags, bread bags, cling wrap, bubble wrap, pasta bags etc. Using soft plastics with a low melting temperature as a binder can help to reduce the amount of virgin low melt plastic binder that is required. In addition to the reduction in landfill waste, this may help to reduce the cost of the products produced by the method. As would be appreciated by one skilled in the art, the amount of recovered waste soft low melt plastic incorporated into the cellulose fibre mixture is determined by the desired ultimate application of the products being made. For example, where density, insulation rating and/or aesthetic appearance are not essential, then larger amounts of recycled plastic can be included into the cellulose fibre mixture.

By re-using the co-mingled recyclable material, a circular economy is facilitated where manufacturing leads to consumption and use, before the materials are recycled for further manufacturing, consumption and use, rather than disposal in a landfill. The recycled cellulose fibre based insulation products also provide a sustainable alternative that is less carbon intensive in comparison with the commonly used fibreglass insulation products. Moreover, the raw materials that are used in manufacturing the cellulose fibre based insulation product are valuable enough to offset the cost of collection and recycling thereby rendering them more environmentally friendly than some alternative forms of insulation products.

The method can, for example, be used to produce an unbound cellulose and plastic based mulch using co-mingled recycled materials from residential, industrial and/or commercial kerbside waste collection, for example using loose fill Cellulose Fibre Insulation (‘CFI’) technology.

Cellulose-based mulch contaminated with plastic can be produced that is suitable for use in landfill tip cover and other agricultural uses where permitted by local authorities, or for the manufacture of cartons and particle fibre boards.

In a further example, the method can be used to produce bound or bonded cellulose fibre-based insulation, pollution retrieval batts and mats, waddings and fibre particle boards, for example using non-woven ‘Airlay’ textile manufacturing technology and thermal bonding ovens. In some forms, the bound insulation products may themselves be recycled once their useful life comes to an end, further improving the value of collecting and recycling the raw materials used in manufacturing the products, and further promoting an environmentally friendly circular economy.

In a variation, organic briquettes can be made with the loose unbonded cellulose fibre mix before it is subject to the airlay and thermal bonding processes. The use of existing briquetting technology can be used to make the briquettes, which may be suitable for use as a substitute for coal or other organic products used as a fuel in furnaces and stoves, such as, but not limited to, wood, paper, cardboard, plastics, and other vegetation material. The briquettes may, in some embodiments, be suitable for use as fuel in generators that can produce electrical power to run the manufacturing facility. In addition, the heat generated by burning of the briquettes may be sufficient for melting the low melt binding polymers. In embodiments where the briquettes are used for generating electrical power, the generator may comprise a system for small scale carbon capture, thereby further reducing greenhouse gas emissions from operation of the generator. Waste items, such as Tetra-Pak type containers or Medicinal Blister Packs or similar, which may be difficult to recycle, may be used as part of the waste materials that are burned in order to produce the briquettes. In some forms, these waste items may also be incorporated, in small amounts, into other cellulose bound products like mats, batts and boards.

The bound or bonded cellulose fibre-based insulation product can be formed into thermal and/or acoustic insulation batts and mats. Alternatively, batts and matts can be formed that are suitable for pollution/spill retrieval/soak-up use in to recovering liquid spills from non-pervious or semi-pervious surfaces.

Alternatively, backing boards can be formed that are ridged and/or flexible and compatible with acoustic, thermal, and/or aesthetic finishes. Alternatively, hard ‘Particle Boards’ can be formed that are suitable for use in place of traditional particle boards, plywood or veneers.

Optionally, ‘scrim’/film can be added to one side or both sides of bound products. These scrims can add structural integrity, stiffness, rigidity, and firmness to the bound products. This may improve the ease of use of the bound insulation products in instances when no or limited support is provided whilst fixing the product in place. This may also improve the aesthetic and finish of the product in instances where the insulation product is covered with a decorative material or an alternative finish, in comparison with an exposed unscrimmed product finish. Scrims can be made from a variety of materials including, but not limited to, metal foils, plastic films, or other thin films that may be either air and/or moisture permeable or non-permeable depending on the intended use of the bound product.

A plurality of individual polymers can be blended from among the recovered soft plastics, with the resulting blend substantially replicating the mechanical properties of a typical commercially acquired low melt binder. Where reference is made to a polymer, this refers to materials formed from a long or larger molecule consisting of a chain or network of many repeating units, formed by chemically bonding together many identical or similar small molecules called monomers. Polymers may be formed from natural polymers, such as collagen, silk, and cellulose, or from synthetic polymers, such as nylon, polyethylene, polyester, Teflon, and epoxy, which are used for reinforcement and to offer mechanical support.

Where reference is made to polymeric fibrous material, this refers to a sub-group of synthetic fibres, which in turn is a subset of artificial fibres. Artificial fibres are generally derived from natural materials through chemical processes, and may comprise semi-synthetic fibres, cellulose regenerated fibres, and synthetic fibres. Synthetic fibres, in turn, are commonly created through the indirect synthesis of petroleum derivatives, and may be further divided into sub-groups including fibreglass, mineral fibres, carbon, silicon carbide and metallic fibres and polymer or polymeric fibres. Polymer fibres are based on synthetic chemicals, often from petrochemical sources, rather than arising from natural materials by a purely physical process. For example, these fibres are made from polyamide nylon, PET or PBT polyester, phenol-formaldehyde (PF), polyvinyl chloride fiber (PVC) vinyon, polyolefins (PP and PE) olefin fiber, acrylic polyesters, carbon fiber made from pure polyester PAN fibres, aromatic polyamides (aramids) such as Twaron, Kevlar and Nomex, polyethylene (PE), elastomers, urethane fibres, polyurethane fibres, and elastolefin. For example, in some forms fibrous materials comprising one or more of polyester, polypropylene and polyethylene may be preferred, in combinations with and/or without additives that render the resulting fibrous material to have biodegradable properties.

The present invention utilises a variety of low-melt polymeric fibrous materials in order to bind other non-low melt polymeric fibrous materials and cellulose material together, thereby forming bound or bonded products including, for example, insulation mats and batts. Non-low melt polymeric fibrous materials are used to influence the resulting material properties of the produced product, for example, but not limited to, in order to reduce density, or to create and maintain product loft and recovery after compression packaging. For example, the polymers of the low melt binder can range from 1-2 deniers in thickness and have a cut length between 3 and 60 mm. In a further example, the polymers of a non-binder polyester intended to promote loft and recovery may comprise a denier count in the range of 15-20 denier with a cut length ranging between 32 and 64 mm. In a further example, the polymeric fibrous materials may comprise simple or conjugated hollow fibres. The hollow fibres may improve the volume, strength, resilience, and thermal insulation of the material, when compared with solid fibres.

As would be understood by one skilled in the art, other cellulose fibres such as, but not limited to, cotton, wool, wood fibres and jute can be added to the mixture of raw materials in order to increase the variety of recycled content. This can also be used to control and create different properties including but not limited to density, finishes, insulation ratings and liquid absorption. Similarly, other virgin polymer fibres can be added to create different densities, thicknesses, insulation ratings and appearances where required. For example, a density in the range of 20 to 30 kg/m³ may be preferred for some embodiments of thermal insulation. A density up to 50 kg/m³ may be preferred for some embodiments of acoustic insulation.

By removing the need for cleaning the raw materials, the cost of manufacturing cellulose based insulation batts and mats may be reduced. Moreover, in some forms the insulation product manufactured by the disclosed method may substitute some or all, of the virgin polymeric binders used to bond the insulation product with a binder comprising recycled soft plastic having a low melting temperature. Using recycled materials, such as soft plastics, that have relatively low melting temperatures (e.g. below approx. 140°-170° Celsius) when compared with fibreglass (e.g. approx. 1500° Celsius) can further help to reduce the carbon footprint and cost of manufacturing insulation products in accordance with the disclosed method.

Some examples of suitable low-melt soft plastics that may commonly be found in co-mingled waste include High Density Polyethylene (HDPE) (e.g. water bottles, bottle caps, folding tables, chairs, food storage containers, plastic bags, water pipes for domestic water supply), Medium Density Polyethylene (MDPE) (e.g. shrink film, carrier bags, screws and enclosures), Linear Low Density Polyethylene (LDPE) (e.g. plastic wrap and food containers), Polypropylene (PP) (e.g. sauce bottles and yogurt containers), all of which have a melting temperature below 170° Celsius. The product can incorporate any of the above waste plastics either singularly or as a blend of some or all these plastics. As would be understood by one skilled in the art, other plastics with a melting point significantly under the melting point of the core of any low melt bi-component fibres incorporated into the mix as a binder, or if used, under the melting point of non-melt staple fibres, can be used. However, it would also be appreciated that lower melting point plastics may be preferable, as this will help to reduce the amount of embodied energy in the final product and the cost to produce the bonded or bound insulation products.

Where the reference is made to the addition or blending of virgin polymeric and or polymer fibres, the amount may be a little as 0% by weight or up to the weights as specified herein. As would be understood by one skilled in the art, in some forms the addition of virgin polymers or polymer fibres may be optional for some of the range of insulation products produced. For example the recycled and/or virgin polymer may comprise one of more PET Polyethylene Terephthalate, PE Polyethylene, PBT Polybutylene Terephthalate, PP Polypropylene, in the form of polyesters, copolyesters and copolymers. Where reference is made to a copolyester, this refers to a polyester that has been modified by the addition of other chemicals. Where reference is made to a copolymer, this refers to a polymer derived from more than one species of monomer.

In some forms it may be preferable that the binder comprise 50% recycled low melt plastic or less, with the remainder being virgin low melt plastic binder. The percentage content of the waste low melt plastics can be increased in instances where the density of the batt needs to be increased, or in instances where the loft of the insulation product and/or having a low density are not essential physical properties, such as when acoustic batts are being produced.

The insulation products produced by the disclosed method can be manufactured to have a relatively low density when compared with prior art bound or bonded cellulose insulation batts and mats. For example, the insulation products can have a density of approximately 25 kg/m3 or less depending on the application. This may reduce the costs of distribution and improve the ease with which the insulation product may be handled.

Surfactants can be used with liquid fire retardants to improve the penetration and encapsulation of the liquid fire retardants in the cellulose fibres. Surfactants may thus improve the efficiency of the fire retarding properties of the products, thereby reducing the volume of fire retardants required to be used for the products to meet fire related standards. Surfactants may also improve the surfaces and the bonding process between the binders and the non-binding materials. Some fire retardants already incorporate surfactants in the liquid.

The surfactants can by synthetic or natural surfactants, anionic or non-anionic, with varying degrees of environmental friendliness, and varying costs to suit different budgets and applications. Application of the surfactants can be performed separately or in conjunction with the fire and/or vermin retarding additives, depending on the surfactant chosen. In some embodiments, the application rate of the surfactant can exceed 0.1% by weight of the product, however in some preferred embodiments, the application rates of the surfactant vary between 0.01% to 0.1% by weight of the product. For example, in embodiments where a non-ionic surfactant is used, such as ethoxylated alcohols, a concentrate of 0.01-0.1% by weight of the product can be used. In some embodiments, bio-based surfactants may be used that comprise components from renewable sources. Bio-based surfactants may be used as ‘green’ alternatives.

Some surfactants are more biodegradable and environmentally friendly than others. A surfactant compatible with cellulose fibres comprising a surface active matter between 67-72%, a pH (5% aqueous) in the range of 5.0-8.0, a Viscosity at 25 C (cP) of 284, a Specific Gravity at 25 C of 1.1, being soluble in water, having a pour point less than 5 and a flash point open cup greater than 100 C, and a surface tension at 0.1% aqueous (mN/m) of 29.32, would be suitable with appropriate dosing equipment. As would be appreciated by a person skilled in the art, variations to the Pour Point, Viscosity and Specific Gravity may be suitable if such variations would be compatible with the liquid retardant injection or spraying equipment.

Referring now to FIG. 1, the method for recovering waste resources first comprises sorting of the collected raw recyclable materials at a Material Recovery Facility (‘MRF’). By aggregating MRF's the combined resulting facility may significantly increase the overall capability and efficiency when dealing with recyclable materials. For example, it may be possible to sort the contents of recycling bins into functional components such as paper, cardboard, plastics and glass sand material for recycling or re-purposing locally.

The sorting process comprises one or more of pre-sorting 101, star screen sorting 102, infrared sorting 108, glass sorting 103, magnetic sorting 104, eddy current sorting 105, optical sorting 106, and manual sorting 107.

Pre-sorting 101 involves staff at the MRF manually removing obvious unwanted contamination from the commodity streams of paper, cardboard, plastic, glass, and metals, with general waste being separated and sent to landfill.

The raw recyclable materials can then be sorted using a star screen 102 and/or an angled star screen 102′, which involves passing the raw materials in between a series of shafts that are fitted with rotating star shaped discs that are adapted to propel paper and cardboard forward, whilst pushing other non-planar and/or non-flattened objects such as bottles, cans and containers to fall backward.

The extracted paper, cardboard and plastics can be optically identified 108 and sorted out from the mixture of raw materials that comes through the star screen 102 and/or an angled star screen 102′. A combination of infrared sensors and compressed air, can be used to further clean and improve the quality of the paper, cardboard and various plastics. The output raw materials comprise cardboard and paper that are suitable for utilisation as raw materials for the cellulose based products on the cellulose fibre products production line 109, and low melt plastics, such as those plastics that have a with melting point below 170° Celsius. In some forms, low melt plastics having a melting point below 190° Celsius may be suitable for use as raw materials. The remaining unsuitable plastics can be separated and repurposed for usage with alternative recycling applications.

The glass extracted by the star screen 102 and/or an angled star screen 102′ can be removed and sent to a glass sorting facility 103 where the glass is sorted according to one or more properties, such as colour. Alternatively, the extracted glass can be sent to a glass crusher 103′.

The remaining mixture of raw materials may still comprise commodity streams of various plastics and metals. These can be further sorted by using magnets to attract magnetic metals such as steel 104 out of the mixture, an electromagnetic field 105 to repel aluminium products out of the mixture, further optical sorting 106, such as infrared sensors and compressed air jets to further sort and refine the remaining plastic types, and finally MRF staff can manually sort the mixture in order to remove the visible contamination.

Referring now to FIG. 2, following the sorting of the various commodities from amongst the collected raw materials, the method for recovering waste resources further involves manufacturing bound and/or unbound fibrous product the comprises integrated cellulose and fibrous materials.

The apparatus that performs that manufacturing and production processes in accordance with the disclosed method utilises a series of conveyors to move the materials between the various stages of the process. The conveyors can be ‘belt’ type conveyors or pneumatic conveyors that utilise fans (e.g. cyclone style industrial fans) and condensers to separate materials from the air stream at the relevant stages of the process. In addition, the fans and dust filters can remove at least some, or substantially all, of the dust from the blended materials to assist with the binding activities. The resulting product may also be less dusty in some instances. This may be especially helpful when batts, mats, rolls, loose fill CFI and mulches are produced using the disclosed apparatus and method. The amount of dust recovered by the fans and filters may be as much as 0.5 tonnes or more during a single manufacturing shift. Optionally, the dust collected can also be recycled into the mulches or formed into briquettes using briquette manufacturing equipment for further reprocessing. This may advantageously assist with further reducing the volume of waste sent to landfill.

A preliminary shredder 2 is used to break down any large pieces of cellulose and/or plastic raw materials into a size that is suitable for processing by a fine shredder, mill or fiberiser 3 into a finer mulch. In some forms, a fiberiser may be preferable. In a similar manner, briquettes of the dust that were extracted by the fans and filters can be recycled through the preliminary shredder 2 and fine shredder 3. The fine mulch is then conveyed to a buffer bin 5. The buffer bin 5 helps to regulate the flow of the cellulose and plastic blended materials being conveyed to the mulch fibre opener 6A and subsequent processes along the production line. Loose fill CFI and mulches 16 can be taken from the buffer bin 5 for production, bagging 17, packaging and palletising 18.

In some forms, a bale breaker 1A can be used to help break up bales of the co-mingled paper, cardboard and plastic that is delivered from the MRF prior to passing through the preliminary shredder 2. In some variations, bales can be broken manually by hand and or by other equipment. In some variation, the sorted waste paper, cardboard and plastic can be conveyed, in a regulated manner, directly from the MRF in an unbaled loose state to the preliminary shredder 2.

In some alternative forms, mulch manufactured and baled offsite 1B consisting of a suitable blend of waste paper, cardboard and plastic can be utilised as the input raw materials. The mulch may or may not be treated with fire and/or vermin retardant treatments during the offsite manufacturing process. Treated and shredded mulch can be input directly into the mulch fibre opener 6A.

All untreated raw materials can be treated with a chemical dosing 4 of fire and/or vermin retardants prior to or during the blending operation in the blender 7. Surfactants can be applied separately to, or simultaneously with, the fire and/or vermin retardants. The chemical dosing 4 apparatus includes a combination of mixing and holding tanks as well as chemical injection equipment for dosing the cellulose materials with fire and vermin retardants and surfactants. The fire and vermin dosing can be in the form of liquid or powdered chemicals. In some instances, boric acid and borax based chemicals may be used to make cellulose fibre fire and vermin resistant, such as Boric Acid and Borax at dosing rates of 12% wt and 6% wt respectively, or powdered or liquid Magnesium Sulphate 9% wt with 4% wt Borax respectively. As would be understood by one skilled in the art, other alternative chemical combinations are known in the art.

In forms where powdered chemicals are used, it may be preferable to incorporate the chemical dosing 4 into the fine shredding 3 step of the production process. In forms where liquid fire and/or vermin retardants or other additives are used, it may be preferable to incorporate the chemical dosing 4 into other steps of the production process, for example after the preliminary shredder 2, after the fine shredding 3, or just before, during or just after the blender 7 steps. In variations where loose fill CFI or mulches 16 are being produced, it may be preferable to incorporate the chemical dosing 4 into the process whilst the mulch is stored in the buffer bin 3.

A mulch fibre opener 6A further opens up the cellulose and plastic material prior to delivery into the blender 7. This can improve the manufacturing process and assist with the proper blending of the polymer fibres. For example, the mulch fibre opener 6A can be used to further reduce density of the mulch, increase the loft of the mulch or to help distribute the plastic through the cellulose component of the mulch. A polymer fibre binder opener 6B can be used to open the polymer low melt binder if required. If the polymer fibre binder opener 6B is not used to open up the virgin polymer binder it can be used to add more soft low melt waste plastic into the binder mixture. A further “other fibre” opener 6C is available for use should other fibres or additional low melt plastic waste be required when manufacturing a product. The manufacturing apparatus also comprises an opener 6D for off-cuts, waste and recycled products that are recovered when cutting a product to size, when manufacturing a waste product, or for a product at the end of their useful lifespan to be recycled again.

After the various raw materials are opened 6A,6B,6C,6D, they are conveyed to the blender 7 where the raw materials are blended into a homogenised state. If not already added previously, fire and/or vermin retardants can be added to the blended mix following the blending in the blender 7. The blended raw materials are then conveyed to the Air Layer 8 where the blended materials are laid on a conveyor in a thickness and density required for the desired final product. The materials are then conveyed onwards to one or more ovens 9. The process of producing a product from co-mingle waste can result in the contaminated waste harbouring ‘germs’, being the microscopic bacteria, viruses, fungi, and protozoa that can cause disease. The oven 9 is therefore at a temperature that is high enough whereby it acts to kill these germs.

Scrims can be added to the product surfaces prior to entering the oven 9 so that the scrim or adhesive attached to the scrim melts and bonds to the cellulose product. Alternatively, scrims can be added after the oven, or to the finish products as a separate process either onsite or offsite.

The ovens 9 can incorporate cold calendaring rollers, which roll the product to the correct thickness and density after leaving the oven. The ovens 9 can also incorporate a cooling section before the product is conveyed to the cutting equipment 10. The product can be trimmed to the desired size or formed into the desired shape by the cutting equipment 10 in order to produce rolls 11A, batts 11B and/or rolls for laminating 11C, as desired. The rolls 11A, batts 11B and/or rolls for laminating 11C are then bagged 12A,12B,12C before being placed on a pallet 13A,13B,14C. The rolls for laminating 11C are conveyed down a foil laminating line 14A before being bagged 14B and palletised 14C. In some forms, the bagging 12A,12B,14B, palletising 13A,13B,14C,18 and laminating 14A may be performed off site.

As would be appreciated by one skilled in the art, the plant and equipment for performing the disclosed method can be varied depending on the type of products produced, the amount of automation required, the production rate required, or the warehousing and distribution processes.

Variations and modifications may be made to the parts previously described without departing from the spirit or ambit of the disclosure.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1-28. (canceled)

29. A method for recovering waste resources to produce an insulation product, the method comprising:
collecting co-mingled commodity streams from a waste source;
sorting and separating cellulose and soft plastics from among the co-mingled commodity streams; and
blending the cellulose and soft plastics together to form a blend of recycled waste; wherein polymeric fibrous material is blended together with the blend of recycled waste and wherein the blend of recycled waste comprises:
about 80-90% by weight cellulose recovered from a waste source, and
about 10-20% by weight of the soft plastic and the polymeric fibrous material;
passing the blend of recycled waste through one or more oven modules operating at a temperature high enough to melt the soft plastic and/or the polymeric fibrous material whereby the blend of recycled waste produces the insulation product.

30. The method according to claim 29, wherein the polymeric fibres include low-melt polymeric fibrous materials and non-low-melt polymeric fibrous materials and/or wherein the cellulose includes at least one of paper or cardboard.

31. The method according to claim 29, wherein the polymeric fibrous materials binds the blend of recycled waste to produce the insulation product.

32. The method according to claim 29, wherein prior to the blending step, the method further comprises shredding the cellulose and soft plastics into smaller particles.

33. The method according to claim 32, wherein the shredding step of the method comprises a first shredding of the cellulose and soft plastics to a first particle size and a second shredding, milling and/or fiberizing of the cellulose and soft plastics to a second, smaller particle size, and wherein the first particle size has an average particle size of between about 10 to 50 mm in diameter and the second particle size has an average particle size of between about 2 to 10 mm in diameter.

34. The method according to claim 29, wherein the method further comprises adding fire and/or vermin retardants to the blend of recycled waste either before or after the blending step; and/or wherein the method further comprises adding surfactants and/or other additives to the blend of recycled waste either before or after the blending step.

35. The method according to claim 34, wherein the blend of recycled waste comprises about 5-10% by weight fire and/or vermin retardants and/or surfactants.

36. The method according to claim 29, wherein the soft plastics have a melting temperature below 170° Celsius.

37. The method according to claim 29, wherein the blend of recycled waste comprises less than 50% of the soft plastics that have been recycled.

38. The method according to claim 29, wherein the soft plastics comprise one or more of High Density Polyethylene (HDPE), Medium Density Polyethylene (MDPE), Linear Low Density Polyethylene (LDPE), Polypropylene (PP), and Low Density Polyethylene (LDPE).

39. The method according to claim 29, wherein the method further comprises, prior to passing the blend of recycled waste through one or more oven modules, laying the blend of recycled waste on a conveyor, and wherein in the laying step, the blend of recycled waste is formed into one or more of an unbound mat, batt, sheet, and/or board.

40. The method according to claim 39, wherein non-woven Airlay textile technology is used in the laying step.

41. An insulation product, the insulation product comprising a blend of raw materials from one or more commodity streams collected from a co-mingled waste source, the one or more commodity streams including at least one or both of cellulose and soft plastics,
wherein polymeric fibrous material are added to the blend of raw materials and wherein the blend of raw materials comprises about 80-90% by weight cellulose recovered from a waste source, and about 10-20% by weight of the soft plastic and the polymeric fibrous material; and
wherein the soft plastic and/or the polymeric fibrous material of the blend of raw materials have a melting temperature, whereby in use when the blend is passed through one or more over, the soft plastic and/or the polymeric fibrous material are able to melt whereby the blend produces an insulation product.

42. The insulation product according to claim 41, wherein the cellulose includes at least one of paper or cardboard and/or wherein the polymeric fibres include low-melt polymeric fibrous materials and non-low-melt polymeric fibrous materials.

43. The insulation product according to claim 41, wherein the soft plastics and/or the polymeric fibrous material have a melting temperature below 170° Celsius.

44. The insulation product according to claim 41, wherein fire and/or vermin retardants and/or surfactants are added to the blend of raw materials.

45. The insulation product according to claim 41, wherein the insulation product is unbound.

46. The insulation product according to claim 41, wherein the insulation product is formed into bound or bonded cellulose fibre-based insulation.

47. The insulation product according to claim 46, wherein the polymeric fibrous materials binds the blend of recycled waste to produce the insulation product.

48. A method of producing insulation materials from a waste source, the method comprising:
collecting co-mingled commodity streams from the waste source;
sorting and separating cellulose and soft plastics from among the co-mingled commodity streams; and
blending the cellulose and soft plastics together to form a blend of recycled waste;
wherein polymeric fibrous material is blended together with the blend of recycled waste and wherein the blend of recycled waste comprises:
about 80-90% by weight cellulose recovered from a waste source, and
about 10-20% by weight of the soft plastic and the polymeric fibrous material;
passing the blend of recycled waste through one or more oven modules operating at a temperature high enough to melt the soft plastic and/or the polymeric fibrous material whereby the blend of recycled waste produces an insulation material.
